(19) United States
(12) Patent Application Publication
(10) Pub. No.: US 2006/0159125 A1
(43) Pub. Date: Jul. 20, 2006

(54) System and method for providing central office equipment for high bandwidth communications

(75) Inventors: Farhad Barzegar, Branchburg, NJ (US); Irwin Gerszberg, Kendall Park, NJ (US); Thomas W. Hill JR., Oviedo, FL (US); Scott Joseph Mollica, Red Bank, NJ (US)

Correspondence Address: AT&T CORP., ROOM 2A207, ONE AT&T WAY, BEDMINSTER, NJ, 07921, US

(73) Assignee: AT&T Corp, NEw York, NY (US)

(21) Appl. No.: 11/036,280

(22) Filed: Jan. 14, 2005

(51) Int. Cl. H04J 3/22

(52) U.S. Cl. 370/468; 370/230

(57) ABSTRACT

A method, apparatus, and a machine-readable medium for providing high-quality voice through central office equipment are provided. A signal indicative of a desired amount of bandwidth for a call may be received at the central office equipment. A determination may be made as to whether a desired amount of bandwidth resources associated with the central office equipment is available for the call. The signal indicative of the desired amount of bandwidth resources may be forwarded to a next item in a communications path between a calling audio device and a called audio device when the determination determines that the desired amount of bandwidth resources associated with the central office equipment is available for the call.

### BACKGROUND OF THE INVENTION

1. Field of the Invention

The present invention relates to telecommunications systems and more specifically to telephony equipment capable of supporting high bandwidth communications.

2. Introduction

Human speech produces frequencies that typically he within a frequency band of about 100 Hz to about 8,000 Hz. The range of frequencies which humans can hear is from about 20 Hz to about 20,000 Hz. Traditional telephone systems, for example, Plain Old Telephone Systems (POTS), are filtered to an approximately 3.1 kHz band, which spans from about 300 Hz to about 3,400 Hz, including guard bands. Thus, traditional telephony filters out quite a bit of human-perceptible sound.

The reduction in sound quality over the telephone and/or telephony systems can cause many problems. For example, in normal telephone conversation, sounds or portions of words spoken can be dropped or lost via the low audio bandwidth (approximately 3.1 kHz) provided by the telephone network. These kinds of disturbances can hinder the enjoyment of the conversation. In many languages, small sound nuances can provide different meanings and reduced sound quality and/or audio bandwidth can reduce the capability of hearing and understanding the speaker. Moreover, when the audio signal includes sounds other than speech, such as music, environmental sounds, etc., the reduction in quality and/or enjoyment caused by relatively low audio bandwidth can be substantial.

An enhanced bandwidth for high-quality audio or other broadband applications may be provided over a telephone network only if substantial changes are made to the telephone network's hardware architecture. Conventional Central Office (CO) equipment as well as POTS networks cannot handle the bandwidth required by high-bandwidth applications, such as high-quality audio and other applications. A new architecture capable of providing greater bandwidth for high-bandwidth applications is needed.

### SUMMARY OF THE INVENTION

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

One aspect of the invention pertains to a method of providing high-quality voice through central office equipment. A signal indicative of a desired amount of bandwidth for a call may be received at the central office equipment. A determination may be made as to whether a desired amount of bandwidth resources associated with the central office equipment is available for the call. The signal indicative of the desired amount of bandwidth resources may be forwarded to a next item in a communications path between a calling audio device and a called audio device when the determination determines that the desired amount of bandwidth resources associated with the central office equipment is available for the call.

A second aspect of the invention pertains to an apparatus for use in providing high bandwidth telephony service. The apparatus may include a processor and a memory that includes instructions for the processor. The processor is configured to receive a signal indicative of a desired amount of bandwidth for a call, determine whether the desired amount of bandwidth resources associated with the apparatus is available for the call, and forward the signal, indicative of the desired amount of bandwidth resources, to a next item in a communications path between a calling audio device and a called audio device when the desired amount of bandwidth resources associated with the apparatus is determined to be available for the call.

A third aspect of the invention pertains to a machine-readable medium having instructions for a processor stored therein. The instructions include a set of instructions for receiving a signal indicative of a desired amount of bandwidth for a call, a set of instructions for determining whether the desired amount of bandwidth resources is available for the call, and a set of instructions for forwarding the signal, indicative of the desired amount of bandwidth resources, to a next item in a communications path between a calling audio device and a called audio device when the resources for the desired amount of bandwidth resources is determined to be available for the call.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system consistent with principles of the invention;

FIG. 2 illustrates an exemplary processing system which may be used to implement wideband central office equipment shown in the exemplary system of FIG. 1;

FIGS. 3-6 provide several examples which illustrate exemplary operation of implementations consistent with the principles of the invention; and

FIGS. 7-9 are flowcharts that illustrate exemplary processing in implementations consistent with the principles of the invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

### Overview

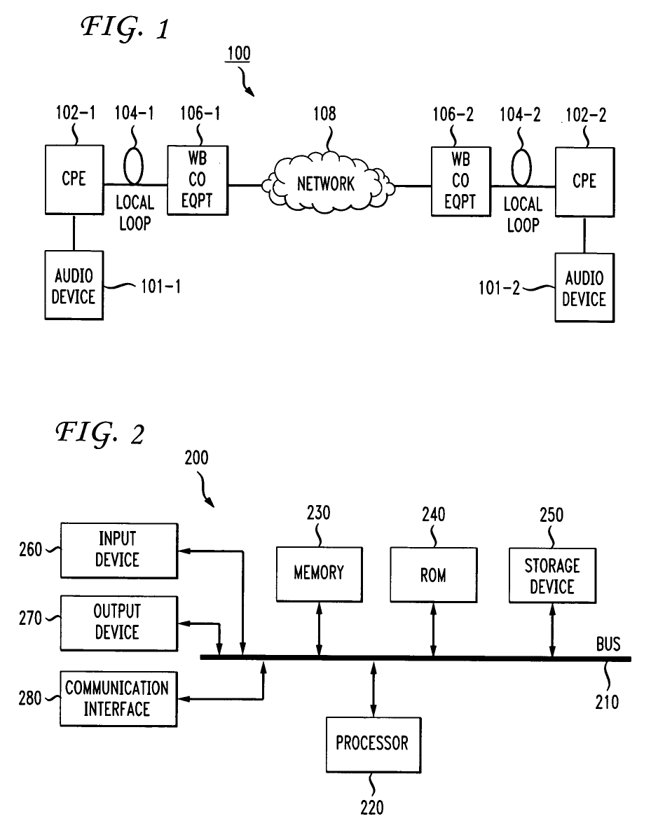

Existing Network Terminating Equipment (NTE) in a Central Office (CO) of a telephone service provider is not capable of providing high bandwidth in a High-Quality Voice Network Architecture (HQVNA) that may provide high-quality audio and other services. FIG. 1 illustrates an exemplary system 100 that provides high bandwidth in a HQVNA. System 100 may include audio devices 101-1, 101-2 (collectively referred to as 101), Customer Premises Equipment (CPE) 102-1, 102-2 (collectively referred to as 102), local loops 104-1, 104-2 (collectively referred to as 104), wideband CO equipment 106-1, 106-2 (collectively referred to as 106), and a high-speed network 108.

In implementations consistent with the principles of the invention, audio devices 101 may include a number of different devices capable of transmitting and/or receiving audio signals. For example, audio devices 101 may include, but not be limited to, such devices as a corded telephone, a microphone, audio gear (a MIDI component, a receiver, a player, an amplifier, an equalizer, a conditioner, a sampler, a recorder, etc.), an audio player/recorder (which may include video capabilities as well), an telephone integrated with a CPE, a speaker, headphones, and a cordless telephone. Audio devices 101 may include an acoustic transducer and may be capable of generating, transmitting, receiving, processing, and/or playing an audio and/or video signal having a bandwidth from approximately 3.1 kHz to approximately 20 kHz, including all values and subranges therebetween.

Audio devices 101 may be coupled via, for example, local loops 104, to wideband CO equipment 106, such as for example, a NTE, which may be connected to network 108.

Network 108 may include a telecommunications network, a telephone network, and/or a Public Switched Telephone Network (PSTN) or any combination of the above. Network 108 may include a broadband network, which may utilize any of a variety of technologies, such as, for example, Integrated Services Digital Network (ISDN), cable, Digital Subscriber Line (DSL), T1, wireless, etc. Higher level audio protocols utilized on and/or over network 108 may include Voice over IP (VoIP), Voice over ATM (VoATM), and/or Voice over Frame Relay (VoFR), as well as other protocols.

In some implementations consistent with the principles of the invention, a calling audio device 101-1 may negotiate a desired amount of bandwidth via CPE 102-1 through wideband CO equipment 106-1, network 108, destination CO equipment 106-2, destination CPE 102-2 to destination audio device 101-2. The desired amount of bandwidth may be granted, at which point, a high-bandwidth call may be established. If the desired amount of bandwidth is not available, the call may be delayed until a time when the desired resources are available. Further, the desired amount of resources may not currently be available, but a lesser amount of resources may be available, at which point calling audio device 101-1 may make a call and use a less than desired bandwidth.

System 100 illustrates an exemplary implementation of a system. Other implementations may have more, fewer, or different components. For example, a system may include more than two items of wideband CO equipment or as few as one item of wideband CO equipment.

FIG. 2 illustrates an exemplary processing system 200 which may be used to implement wideband CO equipment 106 in some implementations consistent with the principles of the invention. System 200 may include a bus 210, a processor 220, a memory 230, a read only memory (ROM) 240, a storage device 250, an input device 260, an output device 270, and a communication interface 280. Bus 210 may permit communication among the components of system 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media, such as, for example, magnetic or optical recording media and its corresponding drive.

Input device 260 may include one or more conventional mechanisms that permit a user to input information to system 200, such as a keyboard, a mouse, a pen, a voice recognition device, etc. Output device 270 may include one or more conventional mechanisms that output information to the user, including a display, a printer, one or more speakers, or a medium, such as a memory, or a magnetic or optical disk and a corresponding disk drive. Communication interface 280 may include any transceiver-like mechanism that enables system 200 to communicate via a network. For example, communication interface 180 may include a modem, or an Ethernet interface for communicating via a local area network (LAN). Alternatively, communication interface 180 may include other mechanisms for communicating with other devices and/or systems via wired, wireless or optical connections.

System 200 may perform functions in response to processor 220 executing sequences of instructions contained in a computer-readable medium, such as, for example, memory 230, a magnetic disk, or an optical disk. Such instructions may be read into memory 230 from another computer-readable medium, such as storage device 250, or from a separate device via communication interface 280.

### Operational Details

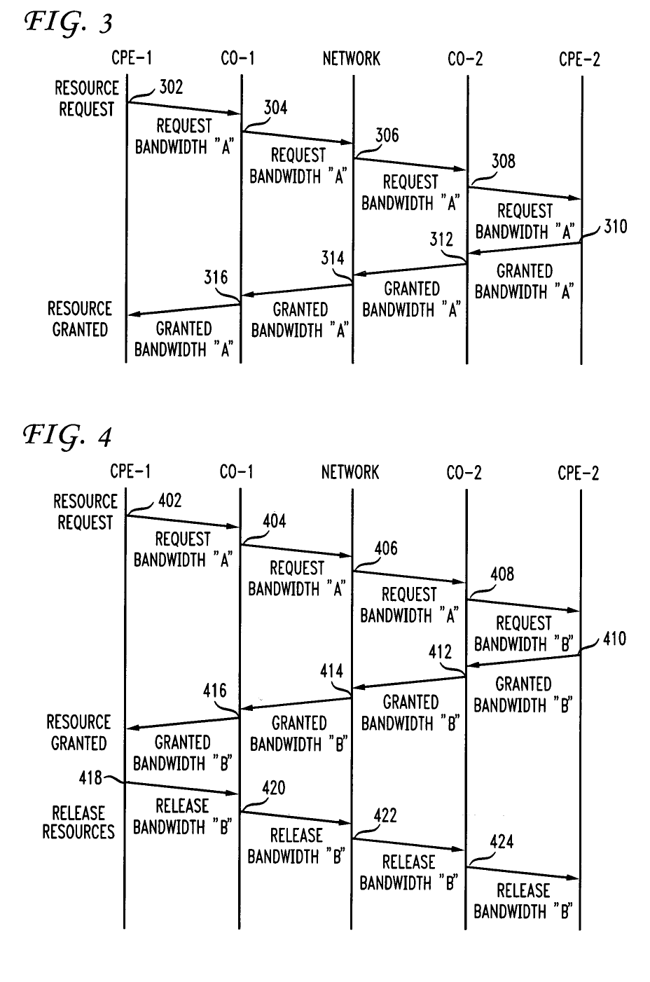

FIG. 3 provides an illustration showing how bandwidth may be negotiated in an implementation consistent with the principles of the invention. A calling audio device may make a request for a particular amount of bandwidth, for example, bandwidth “A”. The request may be made by sending a signal to CPE-1 identifying itself as a particular type of device, wherein the device type may be mapped to a bandwidth “A” requirement by CPE-1. In another implementation, the audio device may identify itself as an audio device requiring a bandwidth of “A” for transmission and “B” for reception. For the sake of simplicity, the following examples of FIGS. 3-6 refer to only to a bandwidth of “A”, “B”, etc., without specifying whether the bandwidth is for transmission or reception. The examples also do not explicitly describe the manner in which audio devices 101 request bandwidth. Although, as suggested above, audio devices 101 may request bandwidth by sending a signal to a CPE identifying itself as a particular type of device, audio devices 101 my request bandwidth by using one or more codes to identify a transmission bandwidth and/or a reception bandwidth, or by indicating a requested transmission and/or reception bandwidth and a minimum acceptable transmission and/or reception bandwidth, as well as other methods.

In FIG. 3, after having received an indication from a connected calling audio device, CPE-1 may determine whether it has the resources to provide the requested bandwidth to the calling audio device. If it does, the CPE-1 may forward the request for bandwidth to a central office (302), where it may be received by wideband CO equipment CO-1. Similar to the CPE-1, CO-1 may also determine whether it has the resources to provide the requested bandwidth to the calling audio device. If CO-1 has the requested bandwidth, then CO-1 may forward the request for bandwidth to a network (304). The network may have a number of components, such as, for example, network nodes, routers, switches, etc. As the request for bandwidth passes through the network, at least some of the components through which it passes may determine whether they can provide the requested bandwidth and may forward the request to a next component in a communications path if the request for bandwidth can be satisfied. The network may then deliver the request for bandwidth to wideband CO equipment CO-2 (306). CO-2 may then determine whether it has the requested resources for the call and if so, CO-2 may forward the request to CPE-2 (308). CPE-2 may determine whether a destination audio device is capable of receiving information at the requested bandwidth. This may be accomplished in a number of different ways. For example, CPE-2 may receive a code from the destination audio device, indicative of the destination audio device's bandwidth requirements, when CPE-2 is first connected with the destination audio device or at some other point in time. Alternatively, CPE-2 may send a signal indicative of the requested bandwidth to the destination audio device and may receive a signal indicating whether the device is capable of sending and/or receiving at the requested bandwidth. Other methods of determining the bandwidth capabilities of destination audio device may also be used.

If CPE-2 determines that the destination audio device is capable of transmitting and/or receiving at the requested bandwidth, then CPE-2 may send a signal to CO-2 indicating that the bandwidth request has been granted (310). Each of the CO-2, the network and it's components, CO-1, and CPE-1 may receive the signal indicating that the bandwidth request has been granted and may forward the signal (312-316). The signal may be delivered by CPE-1 to the originating audio device, at which point call setup may be initiated.

FIG. 4 provides an illustration showing how bandwidth may be negotiated in a second implementation consistent with the principles of the invention. As in the previously-described implementation, a request for bandwidth may be sent from CPE-1 (402) and, assuming the requested resources are available, the request for bandwidth may be forwarded through CO-1 (404), and the network (406) to CO-2. In this example, CO-2 determines that the resources to provide bandwidth “A” are not available, but it can provide a smaller bandwidth, bandwidth “B”, and CO-2 forwards the request for bandwidth to CPE-2, after modifying the requested bandwidth to bandwidth “B”. CPE-2 may determine whether the destination audio device has the resources to transmit and/or receive bandwidth “B” using any of the methods previously described or other methods. IF CPE-2 determines that the destination audio device can operate with the requested bandwidth, then CPE-2 may send a granted bandwidth “B” signal to CO-2 (410). Each of CO-2, the network, and CO-1 may receive the granted bandwidth “B” signal and may forward the signal (412-416). CPE-1 may receive the signal and may indicate to the calling audio device that bandwidth “B” was granted. In this example, the calling audio device may determine that bandwidth “B” is not an acceptable amount of bandwidth and may send a signal CPE-1 indicating this. Alternatively, CPE-1 may already have information regarding the bandwidth capabilities of the calling audio device and may determine that bandwidth “B” is not acceptable. CPE-1 may then send a release bandwidth “B” signal to CO-1 (418) so that the reserved bandwidth may be released and used for other calls. The release bandwidth “B” signal may be forwarded by each of CO-1, the network, CO-2, and CPE-2 (420-424) to release the resources that may have been reserved for a call between the calling audio device and the called audio device. CPE-2 may send a signal to the destination audio device informing it to release resources that may be reserved for a call from the calling audio device.

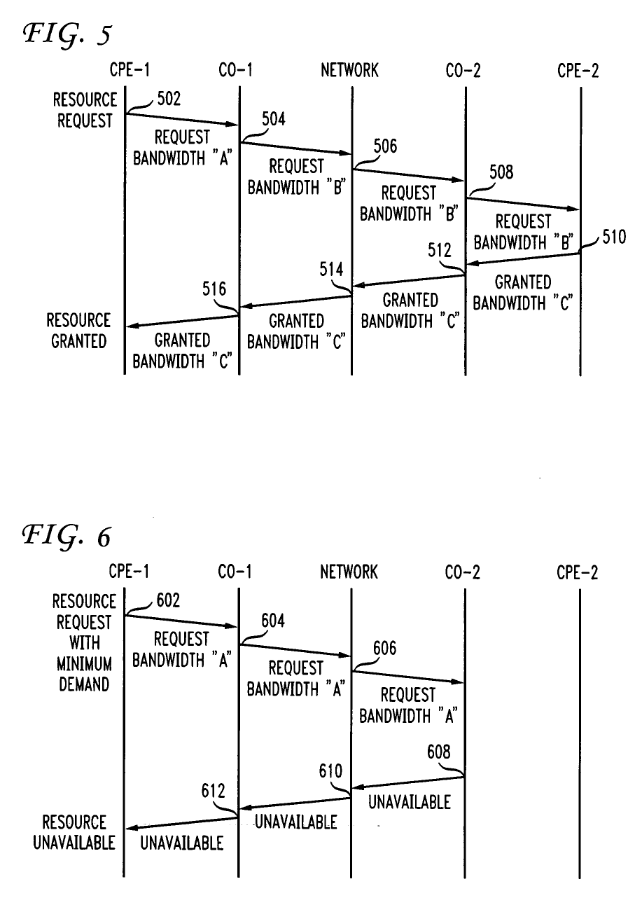

FIG. 5 illustrates another example in which devices along a communication path attempt to negotiate the bandwidth downward. First, CPE-1 may determine that a calling audio device desires to make a call and wishes to request bandwidth “A” for the call. CPE-1 may determine that it has the resources to provide bandwidth “A” and may send a request bandwidth “A” signal to CO-1 (502). CO-1 may determine whether it has the resources to provide bandwidth “A” for the call. In this example, CO-1 determines that it cannot provide bandwidth “A”, but that it can provide bandwidth “B”, where “B”<“A”, and it may send a request bandwidth “B” signal to the network (504). Components in the network, such as, for example, a network node, router, or switch may determine that resources to provide bandwidth “B” are available and the network may send the request bandwidth “B” signal to the central office equipment CO-2 on the called side of the call (506). CO-2 may determine whether resources are available to provide bandwidth “B” to CPE 2. CO-2 may then send the request bandwidth “B” signal to CPE-2 (508).

The called audio device may receive the request bandwidth “B” signal or equivalent from CPE-2 and may determine whether it has the capability to transmit and/or receive at bandwidth “B”. In this example, the called audio device determines that it cannot operate at bandwidth “B”, but determines that it can operate at bandwidth “C”, where “C”<“B”, and it may send an indication to CPE-2 that it reserved bandwidth “C” for this call. CPE-2 may then forward a granted bandwidth “C” signal to CO-2 (510), which may forward the signal to the network (512), which may forward the signal to CO-1 (514), which may forward the signal to CPE-1 (516). CPE-1 may then send a signal to the calling audio device informing it that bandwidth “C” was granted. The calling audio device may determine that it will make the call with the lower bandwidth, bandwidth “C”.

FIG. 6 illustrates operation of another implementation consistent with the principles of the invention. In this implementation, CPE-1 may send a request bandwidth signal indicating a desired bandwidth and a minimum acceptable bandwidth. Thus, if at least the minimum acceptable bandwidth cannot be provided, the call will not be setup. In this example, first, CPE-1 may receive an indication from the calling audio device that the calling audio device wishes to establish a call to a called audio device with a bandwidth of “A”, but is willing to accept a bandwidth as low as bandwidth “M” if resources are not available to provide the desired bandwidth. Alternatively, CPE-1 may receive an indication from the calling audio device to establish a call with the called audio device and CPE-1 may have prior knowledge that the called audio device desires to establish calls with bandwidth “A”, but is willing to establish a call using a bandwidth as low as bandwidth “M” if bandwidth “A” is not available. CPE-1 may send to CO-1 a request bandwidth “A signal, which may also indicate a minimum acceptable bandwidth, bandwidth “M” (602). CO-1 may determine that it can provide bandwidth “A” and may forward the request bandwidth signal to the network (604). Components of the network in the communications path may each determine that can provide the desires resources for the call and may forward the request bandwidth signal to CO-2 (606). At this point, CO-2 may determine that bandwidth “A” is not available and may also determines that it cannot satisfy a request for bandwidth “M”. CO-2 may then respond by sending a resource unavailable signal to CPE-1 through the network (608), CO-1 (610), and finally to CPE-1 (612). CPE-1 may then signal the calling audio device that the call cannot be established and may indicate that the reason the call cannot be established is a lack of resources.

The examples of FIGS. 3-6 are exemplary. It is important to note that not all calls require equipment at two central offices, as shown in the examples. For example, a call may be attempted between two audio devices that are connected through the same central office. In such a case, the call may not need to be passed through the network.

### CO Equipment Procedures

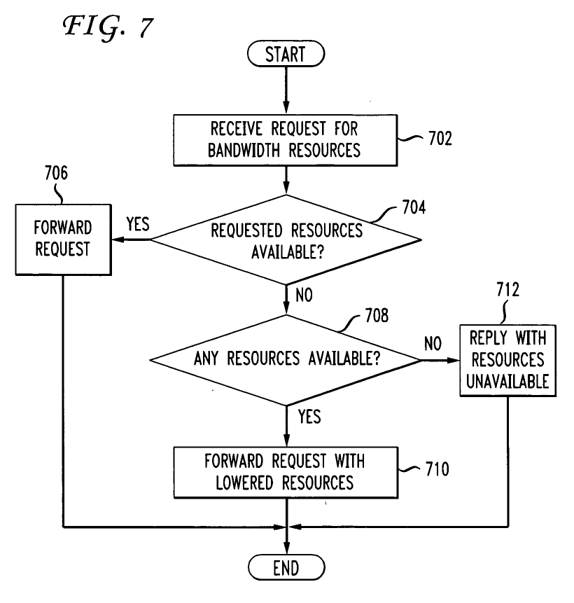

FIG. 7 is a flowchart that illustrates a procedure that may be performed by wideband CO equipment, such as a NTE, in implementations consistent with the principles of the invention. This procedure may be implemented in wideband CO equipment such as that which may operate in the systems of the examples of FIGS. 3-5.

First, the wideband CO equipment may receive a signal from a connected CPE or a network indicating a request for bandwidth resources (act 702). The wideband CO equipment may then determine whether it has resources available to provide the requested bandwidth (act 704). In one implementation consistent with the principles of the invention, the wideband CO equipment may make this determination by checking an amount of bandwidth that is currently reserved for calls and comparing that amount to the known capabilities of the wideband CO equipment, as it is configured. The wideband CO equipment may also determine whether any connections that may be required for the call are available and whether those connections have the requested bandwidth available for the call. For example, the wideband CO equipment may check communication traffic statistics to determine whether any of the connections directly connected with the wideband CO equipment and that may be needed for the call are congested. If the requested resources are available, then wideband CO equipment may forward the request bandwidth signal to the next item in the communications path (the network or the CPE) (act 706).

If, at act 704, the wideband CO equipment determines that the requested resources are not available then the wideband CO equipment may determine if any resources are available for the call (act 708). If some resources are determined to be available, then the wideband CO equipment may modify the requested bandwidth to a lowered amount, consistent with the amount of resources that are available, and may then forward the request bandwidth signal to the next item in the communications path (the network or the CPE) (act 710).

If, at act 708, the wideband CO equipment determines that no resources are currently available for the call, then the wideband CO equipment may reply to the item in the communications path that sent the request bandwidth signal with a resources unavailable signal (act 712).

In the implementation of FIG. 7, when a granted bandwidth signal is received by the wideband CO equipment, the wideband CO equipment may reserve the granted bandwidth for the call and may forward the granted bandwidth signal to the next item in the communications path.

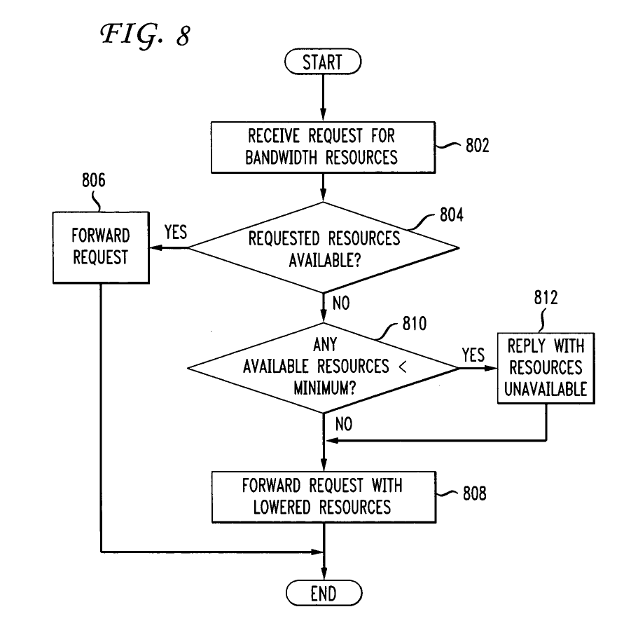

FIG. 8 is a flowchart of a procedure that may be performed by wideband CO equipment, such as a NTE, in another implementation consistent with the principles of the invention. In this implementation, the request for bandwidth signal may include a desired bandwidth and a minimum acceptable bandwidth. First, the wideband CO equipment may receive a request for bandwidth resources either from a CPE or a network (act 802). The wideband CO equipment may then determine whether the requested bandwidth resources are available (act 804). If the wideband CO equipment determines that the requested desired bandwidth resources are available, then the wideband CO equipment may forward the bandwidth request to the next item in the communications path (for example, the CPE or the network) (act 806).

If, at act 804, the wideband CO equipment determines that the requested resources are not available, then the wideband CO equipment may determine whether the available resources are less than the minimum acceptable bandwidth (act 810). If the wideband CO equipment determines that the available resources are less than the minimum acceptable bandwidth, then the wideband CO equipment may reply to the sender of the request for bandwidth with a resources unavailable signal (act 812). Otherwise, the request for bandwidth may be modified to request a lower amount of bandwidth and may be forwarded to the next item in the communications path (for example, the CPE or the network) (act 808).

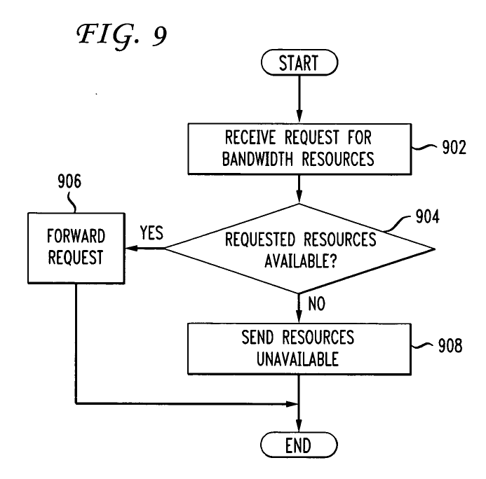

FIG. 9 is a flowchart of a procedure that may be performed by wideband CO equipment, such as a NTE, in another implementation consistent with the principles of the invention. In this implementation, the wideband CO equipment may either grant the requested resources or deny the requested resources. First, the wideband CO equipment may receive a request for bandwidth signal from, for example, the CPE or the network (act 902). The wideband CO equipment may then determine whether the requested resources are available (act 904). This may be accomplished in a manner as described earlier or via another method. If the wideband CO equipment determines that the request bandwidth is available, then the wideband CO equipment may forward the request for bandwidth to the next item in the communications path (act 906). Otherwise, the wideband CO equipment may reply with a resources unavailable signal.

### Variations

The above examples and procedures are exemplary. There are a number of possible ways to provide implementations consistent with the principles of the invention. For example, a subscriber database may include information regarding bandwidth requirements of audio devices. The database may be accessible by, for example, CPEs. Thus, when a CPE receives an indication that the connected audio device wishes to make a call, the CPE may access the bandwidth requirements of the connected audio device via the subscriber database or alternatively, may have previously accessed and stored the connected audio device's bandwidth requirements from the subscriber database. In such an implementation, the CPE must be aware of and update audio device bandwidth requirements if the connected audio device is changed. Thus, the CPE may determine when the connected audio device is changed by, for example, a particular signal sent by the audio device when it is first connected. When the particular signal is received, the CPE may update its information with respect to the audio device and may send an update signal to the subscriber database to keep the database up-to-date. Other methods of keeping the database updated may be obvious to those of ordinary skill in the art in view of description in this specification and the claims.

### CONCLUSIONS

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the invention are part of the scope of this invention. For example, the order of acts in the exemplary processes illustrated by the flowcharts of FIGS. 7-9 may be changed. Accordingly, the appended claims and their legal equivalents should only define the invention, rather than any specific examples given.

We claim as our invention:

1. A method of providing high-quality voice through central office equipment, the method comprising:
receiving, at the central office equipment, a signal indicative of a desired amount of bandwidth for a call;
determining whether the desired amount of bandwidth resources associated with the central office equipment is available for the call; and
forwarding the signal, indicative of the desired amount of bandwidth resources, to a next item in a communications path between a calling audio device and a called audio device when the determining determines that the desired amount of bandwidth resources associated with the central office equipment is available for the call.

2. The method of claim 1, further comprising:
modifying the desired amount of bandwidth resources indicated by the signal to a lowered amount of bandwidth resources when the determining determines that the desired amount of bandwidth resources cannot be provided and the lowered amount of bandwidth resources can be provided; and
forwarding the signal indicative of the lowered amount of bandwidth resources to the next item in the communications path between the calling audio device and the called audio device.

3. The method of claim 2, further comprising:
determining whether the lowered amount of bandwidth resources is not less than a minimum acceptable amount of bandwidth resources, wherein:
the modifying the desired amount of bandwidth resources indicated by the signal and the forwarding the signal indicative of the lowered amount of bandwidth resources are performed when the lowered amount of bandwidth resources is determined to not be less than the minimum acceptable amount of bandwidth resources.

4. The method of claim 3, further comprising:
replying, to an item in the communications path that forwarded the signal to the central office equipment, with a second signal indicative of unavailable resources when the minimum acceptable amount of bandwidth resources is determined to be unavailable.

5. The method of claim 1, further comprising:
replying, to an item in the communications path that forwarded the signal to the central office equipment, with a second signal indicative of unavailable resources when the determining determines that the desired amount of resources is unavailable.

6. The method of claim 1, further comprising:
replying, to an item in the communications path that forwarded the signal to the central office equipment, with a second signal indicative of unavailable resources when the determining determines that no resources is available for the call.

7. The method of claim 1, further comprising:
receiving a second signal indicative of a grant of bandwidth resources for the call; and
forwarding the second signal through the communications path toward the calling audio device.

8. The method of claim 7, further comprising:
reserving an amount of bandwidth resources for the call as indicated by the second signal.

9. The method of claim 1, further comprising:
releasing bandwidth resources reserved by the central office equipment for the call when a signal is received indicating that bandwidth resources are no longer needed for the call.

10. An apparatus for use in providing high bandwidth telephony service, the apparatus comprising:
a processor; and
a memory including instructions for the processor, wherein the processor is configured to:
receive a signal indicative of a desired amount of bandwidth for a call;
determine whether the desired amount of bandwidth resources associated with the apparatus is available for the call; and
forward the signal, indicative of the desired amount of bandwidth resources, to a next item in a communications path between a calling audio device and a called audio device when the desired amount of bandwidth resources associated with the apparatus is determined to be available for the call.

11. The apparatus of claim 10, wherein the processor is further configured to:
modify the desired amount of bandwidth resources indicated by the signal to a lowered amount of bandwidth resources when the desired amount of bandwidth resources cannot be provided by the apparatus for the call and the lowered amount of bandwidth resources can be provided by the apparatus for the call; and
forward the signal indicative of the lowered amount of bandwidth resources to the next item in the communications path between the calling audio device and the called audio device.

12. The apparatus of claim 11, wherein the processor is further configured to:
determine whether the lowered amount of bandwidth resources is not less than a minimum acceptable amount of bandwidth resources, wherein:
the processor is configured to modify the desired amount of bandwidth resources indicated by the signal and is configured to forward the signal indicative of the lowered amount of bandwidth resources when the lowered amount of bandwidth resources is determined to not be less than a minimum acceptable amount of bandwidth resources.

13. The apparatus of claim 12, wherein the processor is further configured to:
reply, to an item in the communications path that forwarded the signal to the apparatus, with a second signal indicative of unavailable resources when the minimum acceptable amount of bandwidth resources is determined to be unavailable.

14. The apparatus of claim 10, wherein the processor is further configured to:
reply, to the item in the communications path that forwarded the signal, with a second signal indicative of unavailable resources when no resources are determined to be available for the call.

15. The apparatus of claim 10, wherein the processor is further configured to:
reply, to an item in the communications path that forwarded the signal, with a second signal indicative of unavailable resources when the desired amount of resources is determined to be unavailable for the call.

16. The apparatus of claim 10, wherein the processor is further configured to:
receive a second signal indicative of a grant of bandwidth resources for the call, and
forward the second signal through the communications path toward the calling audio device.

17. The apparatus of claim 16, wherein the processor is further configured to:
reserve an amount of bandwidth resources for the call as indicated by the second signal.

18. The apparatus of claim 10, wherein the processor is further configured to:
release bandwidth resources reserved by apparatus for the call when a signal is received indicating that the bandwidth resources are no longer needed for the call.

19. A machine-readable medium having instructions for a processor stored therein, wherein the instructions comprise:
a set of instructions for receiving a signal indicative of a desired amount of bandwidth for a call;
a set of instructions for determining whether the desired amount of bandwidth resources is available for the call; and
a set of instructions for forwarding the signal, indicative of the desired amount of bandwidth resources, to a next item in a communications path between a calling audio device and a called audio device when the desired amount of bandwidth resources is determined to be available for the call.

20. The machine-readable medium of claim 19, further comprising:
a set of instructions for modifying the desired amount of bandwidth resources indicated by the signal to a lowered amount of bandwidth resources when the desired amount of bandwidth resources cannot be provided for the call and the lowered amount of bandwidth resources can be provided for the call; and
a set of instructions for forwarding the signal indicative of the lowered amount of bandwidth resources to the next item in the communications path between the calling audio device and the called audio device.

21. The machine-readable medium of claim 20, further comprising:
a set of instructions for determining whether the lowered amount of bandwidth resources is not less than a minimum acceptable amount of bandwidth resources.

22. The machine-readable medium of claim 21, further comprising:
a set of instructions for replying, to an item in the communications path that forwarded the signal, with a second signal indicative of unavailable resources when the minimum acceptable amount of bandwidth resources are determined to be unavailable.

23. The machine-readable medium of claim 19, further comprising:
a set of instructions for replying, to an item in the communications path that forwarded the signal to the central office equipment, with a second signal indicative of unavailable resources when the desired amount of resources is determined to be unavailable.

24. The machine-readable medium of claim 19, further comprising:
a set of instructions for replying, to an item in the communications path that forwarded the signal, with a second signal indicative of unavailable resources when the determining determines that no resources are available for the call.

25. The machine-readable medium of claim 19, further comprising:
a set of instructions for receiving a second signal indicative of a grant of bandwidth resources for the call; and
a set of instructions for forwarding the second signal through the communications path toward the calling audio device.

26. The machine-readable medium of claim 25, further comprising:
a set of instructions for reserving an amount of bandwidth resources for the call as indicated by the second signal.

27. The machine-readable medium of claim 19, further comprising:
a set of instructions for releasing reserved bandwidth resources for the call when a signal indicating that bandwidth resources are no longer needed for the call is received.

28. An apparatus for use in providing high bandwidth telephony service, the apparatus comprising:
means for receiving a signal indicative of a desired amount of bandwidth for a call;
means for determining whether the desired amount of bandwidth resources is available for the call; and
means for forwarding the signal, indicative of the desired amount of bandwidth resources, to a next item in a communications path between a calling audio device and a called audio device when the means for determining determines that the desired amount of bandwidth resources is available for the call.
